(19) United States
(12) Patent Application Publication
(10) Pub. No.: US 2019/0341655 A1
(43) Pub. Date: Nov. 7, 2019

(54) MODULAR MULTI-CELL BATTERY

(71) Applicant: BSB Power Company Ltd, Shenzhen (CN)

(72) Inventors: Zumeng HAN, Shenzhen (CN); Zejun Peng, Shenzhen (CN); Zide ZHU, Shenzhen (CN)

(21) Appl. No.: 15/749,774

(22) PCT Filed: Oct. 9, 2016
(86) PCT No.: PCT/CN2016/101532

§ 371 Date: Feb. 1, 2018

(51) Int. Cl. H01M 10/18; H01M 10/14; H01M 2/10; H01M 2/26; H01M 2/28; H01M 4/73; H01M 4/74

(52) U.S. Cl. CPC H01M 10/18; H01M 10/14; H01M 2/1077; H01M 4/747; H01M 2/266; H01M 2/28; H01M 4/73; H01M 2/1094

(57) ABSTRACT

Disclosed is a modular multi-cell battery, comprising: a battery core comprising a plurality of bipolar plates, a positiveterminal polar plate, a negative-terminal polar plate and a membrane; a pressure frame; a pressure cover plate cooperating with the pressure frame to fix the battery core by means of press fitting; and a battery box and a battery cover for encapsulating the battery core fixed by means of press fitting by the pressure frame and the pressure cover plate. The positive-terminal polar plate, the bipolar plate and the negative-terminal polar plate are placed horizontally and alternately, wherein the membrane is placed between various upper and lower polar plates. The present application has new features of high specific energy, high-power charging and discharging, a strong anti-vibration capacity, a long life cycle, etc., and these advantages are all incomparable to the existing conventional battery technology; moreover, the present application further ensures that other excellent performances of a conventional lead-acid battery are not affected, and some performances reach the level of lithium batteries.

### TECHNICAL FIELD

The present application relates to the field of storage batteries, particularly to a modular multi-cell battery.

### BACKGROUND ART

A first disadvantage of conventional closed-cell lead-acid batteries is the electrolyte stratification phenomenon resulting from vertical placement of the battery electrode plates therein. The electrolyte stratification phenomenon, that is, the polarization phenomenon of electrolyte concentration difference, is one of the main reasons for decreased capacity and shortened life of the battery. A second disadvantage is that cells inside conventional lead-acid batteries are welded by lead tabs to achieve electrical connection. This greatly increases battery internal resistance, which does not permit high-power discharging and fast charging of the battery. A third disadvantage of conventional lead-acid batteries is that the assembling pressure in the battery is sustained by the battery shell after the electrode plates are assembled. Thus, under strong impact, conventional lead-acid batteries will fail due to easy deformation of the structure of the battery, exhibiting a poor anti-vibration capability. A fourth disadvantage is that conventional battery production causes serious environmental pollution resulting from the grid lead alloy smelting and grid casting molding process, and the external formation process which generates acid- and heavy metal-containing waste water from electrode plate washing.

### SUMMARY OF THE INVENTION

According to a first aspect, an embodiment provides a modular multi-cell battery, comprising:

a battery core comprising a bipolar electrode plate, a positive terminal electrode plate, a negative terminal electrode plate and a separator which are provided in plural numbers respectively; wherein one half of the bipolar electrode plate is coated with a positive active material to serve as a positive electrode plate, and the other half is coated with a negative active material to serve as a negative electrode plate, with a gap in between the positive electrode plate and the negative electrode plate, which is not coated with either the positive active material or the negative active material, and which is configured for electrical connection between cells; the positive terminal electrode plate is coated with a positive active material to serve as a positive electrode plate, one side of the positive terminal electrode plate having a region which is left uncoated with the positive active material and which serves as a positive electrode output terminal of the battery core; the negative terminal electrode plate is coated with a negative active material to serve as a negative electrode plate, one side of the negative terminal electrode plate having a region which is left uncoated with the negative active material and which serves as a negative electrode output terminal of the battery core; and the separator serves to absorb acid so that the bipolar electrode plate, the positive terminal electrode plate and the negative terminal electrode plate undergo electrochemical reactions to generate electricity;

a pressure frame having a bottom side face and a plurality of lateral side faces and being configured for housing the battery core;

a pressure cover plate, which in cooperation with the pressure frame, serves to press-fit the battery core and form the cells of the battery, the cells being separated by an insulation material;

a battery case and a battery cover, which serve to encapsulate the battery core having been press-fit by the pressure frame and the pressure cover plate;

wherein the positive terminal electrode plate, the bipolar electrode plate and the negative terminal electrode plate are placed horizontally and alternately, and the separator is placed between an upper electrode plate and a lower electrode plate.

In a preferred embodiment, a hole is formed at a cell boundary on the exterior of a side face of the pressure frame for injecting the insulation material.

In a preferred embodiment, the pressure frame further has a raised edge, and the pressure cover plate further has a groove that engages with the raised edge.

In a preferred embodiment, an inward groove is formed at a cell boundary on the interior of the bottom side face and the lateral side faces of the pressure frame to provide a better sealing effect between the cells when injecting the insulation material.

In a preferred embodiment, the pressure cover plate has a safety valve hole in the same number as that of the cells, the safety valve hole being configured for acid injection into and gas exhaustion from the respective cell.

In a preferred embodiment, the safety valve hole is equipped with a safety valve.

In a preferred embodiment, the pressure cover plate and the pressure frame engages with each other, with epoxy adhesive being applied to the joint of the pressure cover plate and the pressure frame for bonding the pressure cover plate and the pressure frame and isolating the cells from the outside.

In a preferred embodiment, the positive terminal electrode plate is placed in a first cell or a last cell, and correspondingly, the negative terminal electrode plate is placed in the last cell or the first cell; the modular multi-cell battery also comprises two cast terminals respectively for electrical connection to the region of the positive terminal electrode plate or the negative terminal electrode plate not coated with the active material and respectively serving as the positive electrode output terminal or the negative electrode output terminal of the modular multi-cell battery.

In a preferred embodiment, epoxy adhesive is applied to the joint of the battery case and the battery cover, and the battery case further has a safety valve hole, the safety valve hole being equipped with a safety valve.

In a preferred embodiment, the bipolar electrode plate is of a quasi-bipolar structure, which is fabricated using a solid-state extrusion process whereby a lead-coated glass fiber is made into a lead wire which is then woven into a lead grid, and one half of the lead grid is coated with a positive active material to serve as a positive electrode plate, and the other half of the lead grid is coated with a negative active material to serve as a negative electrode plate, with a gap of about 10 mm between the positive active material and the negative active material of the bipolar electrode plate, which is configured for wire connection between cells; the positive terminal electrode plate is fabricated using a solid-state extrusion process whereby a lead-coated glass fiber is made into a lead wire which is then woven into a lead grid, and the lead grid is coated with a positive active material, with one side of the electrode plate having a region which is left uncoated with the positive active material and which serves as a terminal of the positive terminal electrode plate; and the negative terminal electrode plate is fabricated using a solid-state extrusion process whereby a lead-coated glass fiber is made into a lead wire which is then woven into a lead grid, and the lead grid is coated with a negative active material, with one side of the electrode plate having a region which is left uncoated with the negative active material and which serves as a terminal of the negative terminal electrode plate.

The modular multi-cell battery according the above embodiments avoids the phenomenon of electrolyte stratification associated with conventional batteries, because the positive terminal electrode plate, the bipolar electrode plate and the negative terminal electrode plate are placed horizontally and alternately, and the separator is placed between an upper electrode plate and a lower electrode plate.

The modular multi-cell battery according the above embodiments, by using the bipolar electrode plate with a gap which is not coated with either the positive active material or the negative active material and which is configured for electrical connection between cells, achieves reliable electrical connection of single batteries between internal cells without the problem of high internal resistance associated with conventional tab welding, thus permitting high-power discharging and fast charging.

The modular multi-cell battery according the above embodiments, by using the pressure frame and the pressure cover plate that engage with each other to press-fit the battery core, solves the problems of electrode plate deformation due to expansion and of easy peeling of the active materials, while significantly enhancing the anti-vibration and anti-impact capabilities of the battery.

The modular multi-cell battery according the above embodiments, by forming a hole at a cell boundary on the exterior of a side face of the pressure frame for injecting an insulation material such as asphalt and/or epoxy adhesive to isolate the cells of the battery and prevent a flow of acid liquid and acid gas between the cells, avoids inconsistent internal reactions during storage or during charging or discharging of the battery resulting from the flow between the cells, avoids the inconsistency in self-discharging between the cells of the battery and between the single batteries, and ensures the consistency of the cells and the life of the battery.

The modular multi-cell battery according the above embodiments greatly enhances the anti-corrosion performance of the electrode plates because the electrode plates are made by a solid-state extrusion process whereby a lead-coated glass fiber is made into a lead wire which is then woven into a lead grid.

The modular multi-cell battery according the above embodiments allows preparing batteries of different voltages in a modular way by adjusting the number of the cells according to needs, which is convenient, effective and simple.

### BRIEF DESCRIPTION OF THE DRAWINGS

FIG. 1 is a cutaway view showing the modular multi-cell battery according to an embodiment of the present application, in which the pressure frame, the pressure cover plate and the battery case are partly cut away to better illustrate the structure of the modular multi-cell battery;

FIGS. 2. (a) and (b) are the front view and the top view of the bipolar electrode plate according to an embodiment of the present application;

FIGS. 3 (a) and (b) are the front view and the top view of the positive terminal electrode plate according to an embodiment of the present application;

FIGS. 4 (a) and (b) are the front view and the top view of the negative terminal electrode plate according to an embodiment of the present application;

FIG. 5 is a structural depiction of the pressure frame according to an embodiment of the present application;

FIG. 6 is a structural depiction of the pressure cover plate according to an embodiment of the present application;

FIG. 7 is a schematic depiction of the battery core having been press-fit by the pressure frame and the pressure cover plate and having been electrically connected with cast terminals according to an embodiment of the present application;

FIG. 8 is a structural depiction of the first layer in the assembling of the modular multi-cell battery according to an embodiment of the present application;

FIG. 9 is a structural depiction of the modular multi-cell battery before being press-fit according to an embodiment of the present application;

FIG. 10 is a schematic depiction of the finished 24V modular multi-cell battery product according to an embodiment of the present application;

FIG. 11 is a structural depiction of the 36V modular multi-cell battery before being press-fit according to an embodiment of the present application;

FIG. 12 is a schematic depiction of the finished 36V modular multi-cell battery product according to an embodiment of the present application;

FIG. 13 is a structural depiction of the 48V modular multi-cell battery before being press-fit according to an embodiment of the present application;

FIG. 14 is a schematic depiction of the finished 48V modular multi-cell battery product according to an embodiment of the present application.

### DETAILED DESCRIPTION OF THE INVENTION

The present application will be further described in detail below with reference to the accompanying drawings.

Referring to FIG. 1 to FIG. 4, the present application provides a modular multi-cell battery, comprising a battery core, a pressure frame 5, a pressure cover plate 6, a battery case 10 and a battery cover 11, which are described in detail below.

The battery core comprises a bipolar electrode plate 1, a positive terminal electrode plate 2, a negative terminal electrode plate 3 and a separator 4 provided in plural numbers respectively.

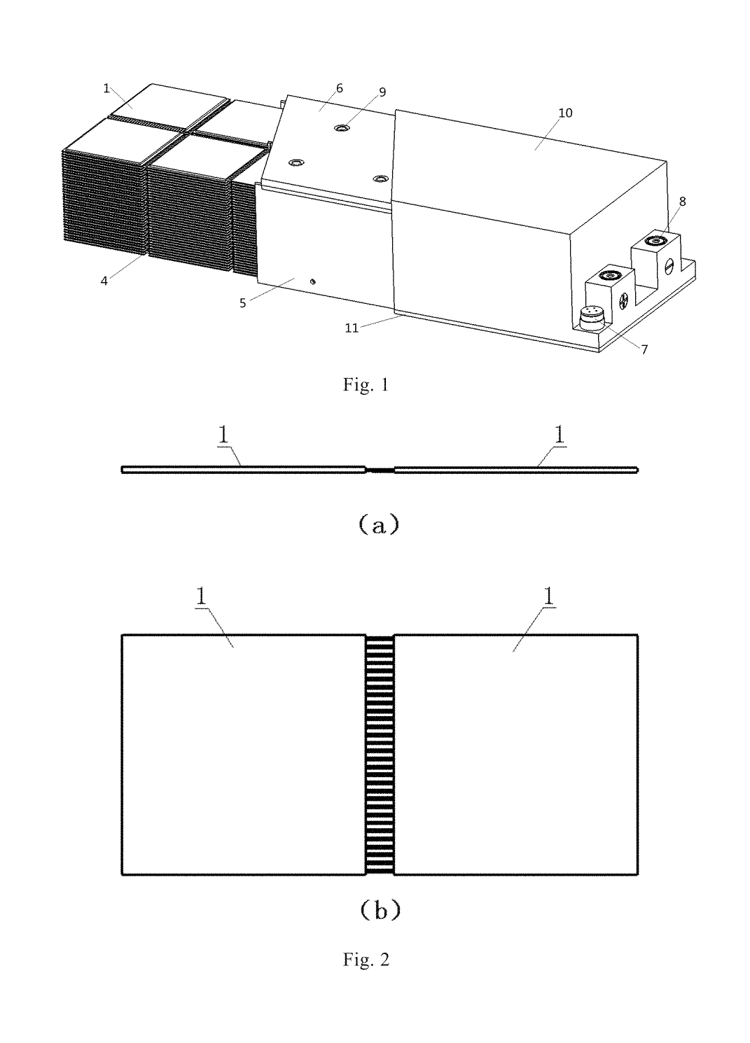

Referring to FIG. 2, one half of the bipolar electrode plate 1 is coated with a positive active material to serve as a positive electrode plate, and the other half is coated with a negative active material to serve as a negative electrode plate, with a gap in between the positive electrode plate and the negative electrode plate, which is not coated with either the positive active material or the negative active material, and which is configured for electrical connection between cells. In a preferred embodiment, the bipolar electrode plate 1 is of a quasi-bipolar structure, which is fabricated using a solid-state extrusion process whereby a lead-coated glass fiber is made into a lead wire which is then woven into a lead grid, and one half of the lead grid is coated with a positive active material to serve as a positive electrode plate, and the other half of the lead grid is coated with a negative active material to serve as a negative electrode plate, with a gap of about 10 mm between the positive active material and the negative active material of the bipolar electrode plate, which is configured for wire connection between cells.

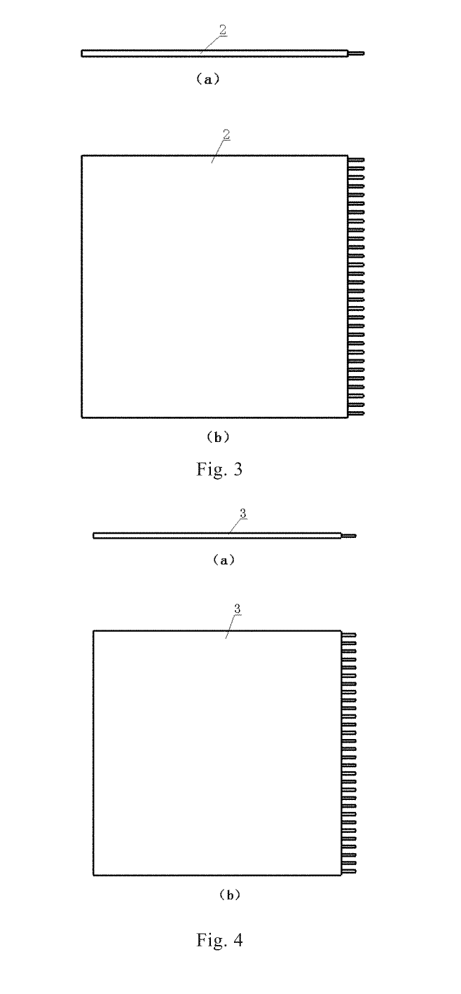

Referring to FIG. 3, the positive terminal electrode plate 2 is coated with a positive active material to serve as a positive electrode plate, one side of the positive terminal electrode plate having a region which is left uncoated with the positive active material and which serves as a positive electrode output terminal of the battery core. In a preferred embodiment, the positive terminal electrode plate 2 is fabricated using a solid-state extrusion process whereby a lead-coated glass fiber is made into a lead wire which is then woven into a lead grid, and the lead grid is coated with a positive active material, with one side of the electrode plate having a region which is left uncoated with the positive active material and which serves as a terminal of the positive terminal electrode plate.

Referring to FIG. 4, the negative terminal electrode plate 3 is coated with a negative active material to serve as a negative electrode plate, one side of the negative terminal electrode plate having a region which is left uncoated with the negative active material and which serves as a negative electrode output terminal of the battery core. In a preferred embodiment, the negative terminal electrode plate 3 is fabricated using a solid-state extrusion process whereby a lead-coated glass fiber is made into a lead wire which is then woven into a lead grid, and the lead grid is coated with a negative active material, with one side of the electrode plate having a region which is left uncoated with the negative active material and which serves as a terminal of the negative terminal electrode plate. As the above-said electrode plates are all fabricated using a solid-state extrusion process whereby a lead-coated glass fiber is made into a lead wire which is then woven into a lead grid, the corrosion resistance of the electrode plates can be greatly improved, and no serious environmental pollution problems will occur during the production process as with traditional battery production.

The separator 4 serves to absorb acid so that the bipolar electrode plate 1, the positive terminal electrode plate 2 and the negative terminal electrode plate 3 undergo electrochemical reactions to generate electricity.

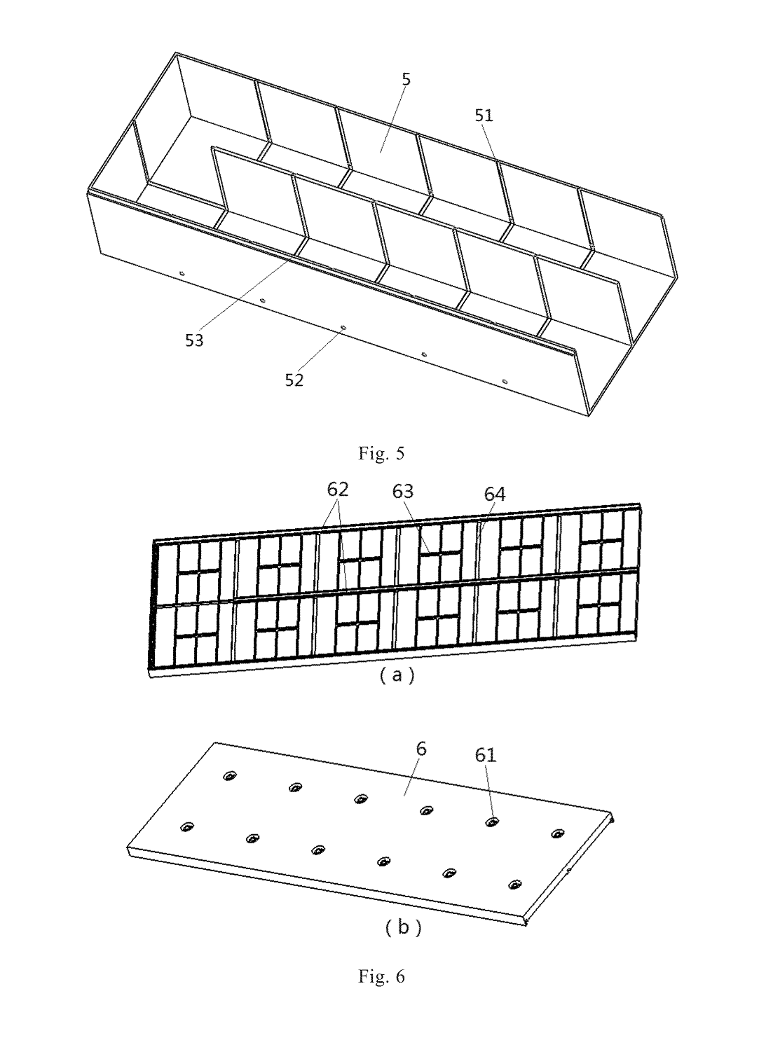

Reference is made to FIG. 5, which is a structural depiction of the pressure frame 5, which can form 12 cells. In an embodiment, the pressure frame 5 has a bottom side face and a plurality of lateral side faces and is configured for housing the battery core. In one embodiment, a hole 52 is formed at a cell boundary on the exterior of a side face of the pressure frame 5 for injecting an insulation material such as asphalt and/or epoxy adhesive. In one embodiment, an inward groove 51 is formed at a cell boundary on the interior of the bottom side face and the lateral side faces of the pressure frame 5 to provide a better sealing effect between the cells when injecting the insulation material.

Reference is made to FIG. 6, which is a structural depiction of the pressure cover plate 6. In an embodiment, the pressure cover plate 6, in cooperation with the pressure frame 5, serves to press-fit the battery core and form the cells of the battery, the cells being separated by the insulation material. In an embodiment, the pressure cover plate 6 has a safety valve hole 61 in the same number as that of the cells, the safety valve holes being configured for acid injection into and gas exhaustion from the respective cells. In an embodiment, the safety valve hole 61 is equipped with a safety valve 9, and the safety valve 9 may be provided with a rubber cap. In an embodiment, the inward side of the pressure cover plate 6, i.e., the side in contact with the battery core, has a groove 63 which serves as a conduit for internal gas exhaustion or acid injection. In an embodiment, a groove 64 is formed at a cell boundary on the inward side of the pressure cover plate 6, the groove serving as a sealing contact face for the adhesive or asphalt with the pressure cover plate 6 when injecting the adhesive or asphalt to ensure a better sealing effect between the cells.

The battery case 10 and the battery cover 11 cooperate with each other to encapsulate the battery core having been press-fit by the pressure frame 5 and the pressure cover plate 6.

In an embodiment, the pressure frame 5 and the pressure cover plate 6 engage with each other via a raised edge 53 on the pressure frame 5 and a groove 62 on the pressure cover plate 6.

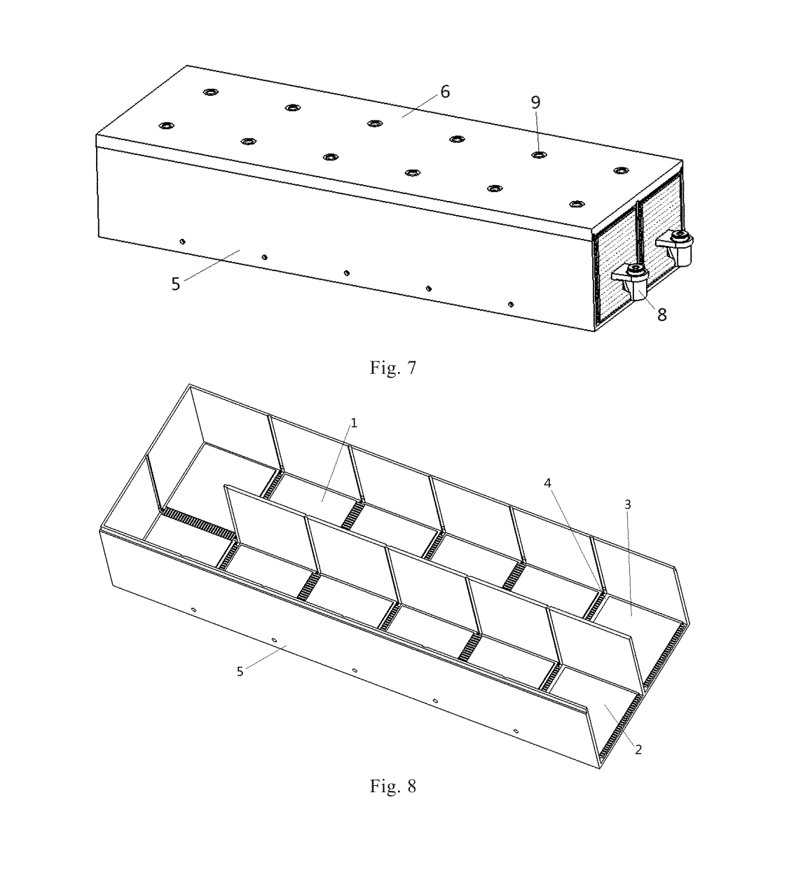

Referring to FIG. 7, the positive terminal electrode plate 2 is placed in a first cell or a last cell, and correspondingly, the negative terminal electrode plate 3 is placed in the last cell or the first cell. The modular multi-cell battery also comprises two cast terminals 8 respectively for electrical connection to the region of the positive terminal electrode plate 2 or the negative terminal electrode plate 3 not coated with the active material and respectively serving as the positive electrode output terminal or the negative electrode output terminal of the modular multi-cell battery.

In the above embodiments, the joint between the raised edge 53 on the pressure frame 5 and the groove 62 on the pressure cover plate 6 is applied with epoxy adhesive for bonding the pressure frame 5 and pressure cover plate 6 and isolating the cells from the outside. Similarly, the joint between the battery case 10 and the battery cover 11 may also be applied with epoxy adhesive for bonding and sealing.

In the above embodiments, the positive terminal electrode plate 2, the bipolar electrode plate 1 and the negative terminal electrode plate 3 are placed horizontally and alternately, and the separator 4 is placed between an upper electrode plate and a lower electrode plate. A practical example is given below for further explanation.

Referring to FIG. 8, the pressure frame 5 is fixed on an assembling equipment. The pressure frame 5 has two transverse assembling positions respectively in the front and the rear, each assembling position accommodating 6 cells, with a total of 12 cells being connected in series. Specifically, assembling is done in the front, left, rear and right directions, with the first cell designated as the front right position, the sixth cell as the front left direction, the seventh cell as the rear left position, and the twelfth cell as the rear right position. The separator 4 is sequentially placed by a machine hand at the cell positions corresponding to the first to the twelfth cells of the pressure frame 5.

Next, the bipolar electrode plate 1 is placed horizontally on the respective separator 4. Specifically, six bipolar electrode plates 1 are placed from the first cell to the twelfth cell, with the negative electrode plate of the first bipolar electrode plate 1 (that is, the region of the bipolar electrode plate 1 coated with the negative active material) being placed on the first cell area, and the positive electrode plate of the first bipolar electrode plate 1 (that is, the region of the bipolar electrode plate 1 coated with the positive active material) being placed on the second cell area; the negative electrode plate of the second bipolar electrode plate 1 being placed on the third cell area, and the positive electrode plate of the second bipolar electrode plate 1 being placed on the fourth cell area; the negative electrode plate of the third bipolar electrode plate 1 being placed on the fifth cell area, and the positive electrode plate of the third bipolar electrode plate 1 being placed on the sixth cell area; the negative electrode plate of the fourth bipolar electrode plate 1 being placed on the seventh cell area, and the positive electrode plate of the fourth bipolar electrode plate 1 being placed on the eighth cell area; the negative electrode plate of the fifth bipolar electrode plate 1 being placed on the ninth cell area, and the positive electrode plate of the fifth bipolar electrode plate 1 being placed on the tenth cell area; and the negative electrode plate of the sixth bipolar electrode plate 1 being placed on the eleventh cell area, and the positive electrode plate of the sixth bipolar electrode plate 1 being placed on the twelfth cell area, such that naturally, a gap of about 10 mm between the positive active material and the negative active material on the bipolar electrode plate 1 is positioned at a cell boundary of the pressure frame 5.

Then, one separator 4 is placed on each cell, with a total of twelve separators being placed on twelve cells, and one separator 4 being placed on each of the positive electrode and the negative electrode of each bipolar electrode plate 1.

Then, one positive terminal electrode plate 2 is placed on the first cell; one negative terminal electrode plate 3 is placed on the twelfth cell; one bipolar electrode plate 1 is placed on the second cell and the third cell, with the positive electrode thereof being positioned on the third cell area and the negative electrode thereof being positioned on the second cell area; one bipolar electrode plate 1 is placed on the fourth cell and the fifth cell, with the positive electrode thereof being positioned on the fifth cell area and the negative electrode thereof being positioned on the fourth cell area; one bipolar electrode plate 1 is placed on the sixth cell and the seventh cell, with the positive electrode thereof being positioned on the seventh cell area and the negative electrode thereof being positioned on the sixth cell area, and the sixth cell and the seventh cell being at the corners of the battery such that said electrode plate is positioned in a front-rear direction perpendicular to other electrode plates; one bipolar electrode plate 1 is placed on the eighth cell and the ninth cell, with the positive electrode thereof being positioned on the ninth cell area and the negative electrode thereof being positioned on the eighth cell area; one bipolar electrode plate 1 is placed on the tenth cell and the eleventh cell, with the positive electrode thereof being positioned on the eleventh cell area and the negative electrode thereof being positioned on the tenth cell area. Moreover, the terminal of the positive terminal electrode plate 2 at the first cell and the terminal of the negative terminal electrode plate 3 at the twelfth cell respectively extend outward in the right direction of the battery.

This completes the assembling of one layer of the battery. The separator 4 and the electrode plates can further be stacked according to the intended layers of the battery.

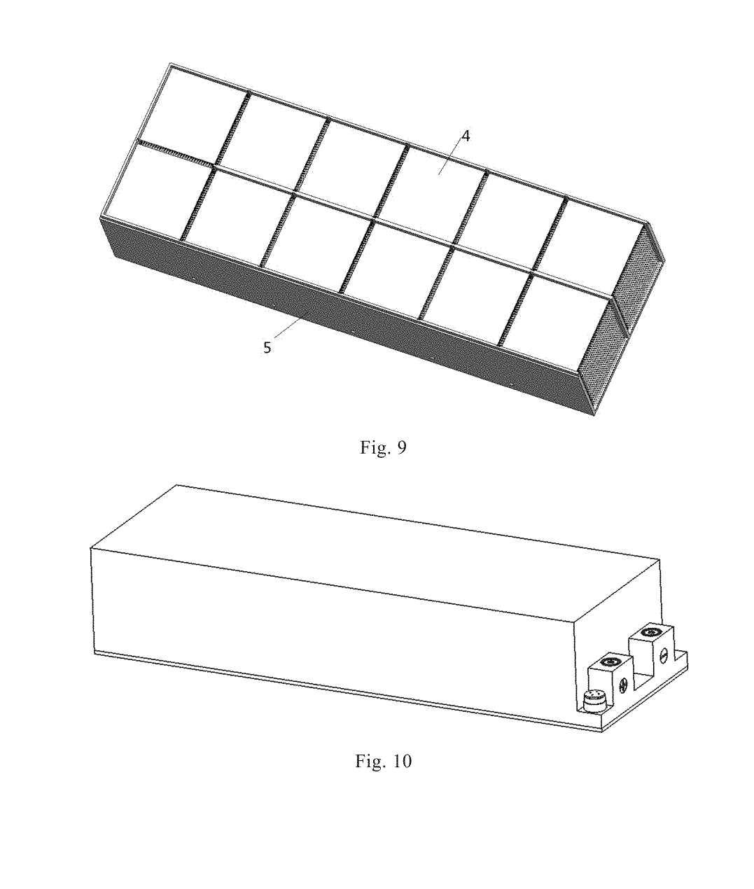

Referring to FIG. 9, the electrode plates are arranged in the direction of from right to left in the front, from left to right in the rear and from bottom to top, such that the positive electrode plates and the negative electrode plates (the positive electrode plates referring to the positive terminal electrode plate 2 and the positive electrode plate on the bipolar electrode plate 1, and the negative electrode plates referring to the negative terminal electrode plate 3 and the negative electrode plate on the bipolar electrode plate 1) are placed alternately, with each electrode plate being enveloped on the top and at the bottom by the separator 4, and with a gap of about 10 mm between the positive active material and the negative active material on the bipolar electrode plate 1 being positioned at a cell boundary of the pressure frame 5. In this way, the assembling of the entire battery core is completed.

Then, the pressure cover plate 6 is placed on the pressure frame 5, with adhesive being applied to the joint thereof. The pressure cover plate 6 and the pressure frame 5 are bonded in place using a press-fitting machine at a press-fitting pressure of up to 100 kPa.

Then, the terminals of the first cell and the twelfth cell of the battery core, that is, the protruding terminals of the positive terminal electrode plate 2 and the negative terminal electrode plate 3, are cast-welded to the respective cast terminals 8 to respectively serve as the positive electrode and the negative electrode of the modular multi-cell battery.

Then, asphalt or adhesive is injected via the hole 52 at a cell boundary on the exterior of a side face of the pressure frame 5 to the extent that the asphalt or adhesive completely fills and seals the cell boundary on the pressure frame 5 and the pressure cover plate 6 such that the cells are isolated. This achieves complete and separate sealing and isolation of the twelve cells.

Then, after vacuuming the battery, acid is injected into the respective cells separately and independently of each other via the safety valve hole 61 on the pressure cover plate 6, followed by subjecting the battery to formation.

After formation, a rubber cap is installed on the safety valve 9, and then the battery case 10 and the battery cover 11 are mounted. Adhesive is applied to the groove on the sealing face of the battery cover 11 and battery case 10 and to the sealing joint of the battery cover 11 and battery case 10 for bonding and sealing to form the protection shell of the battery. Then, an outer safety valve 7 is installed on the battery case 10 to obtain the finished battery, as shown in FIG. 10.

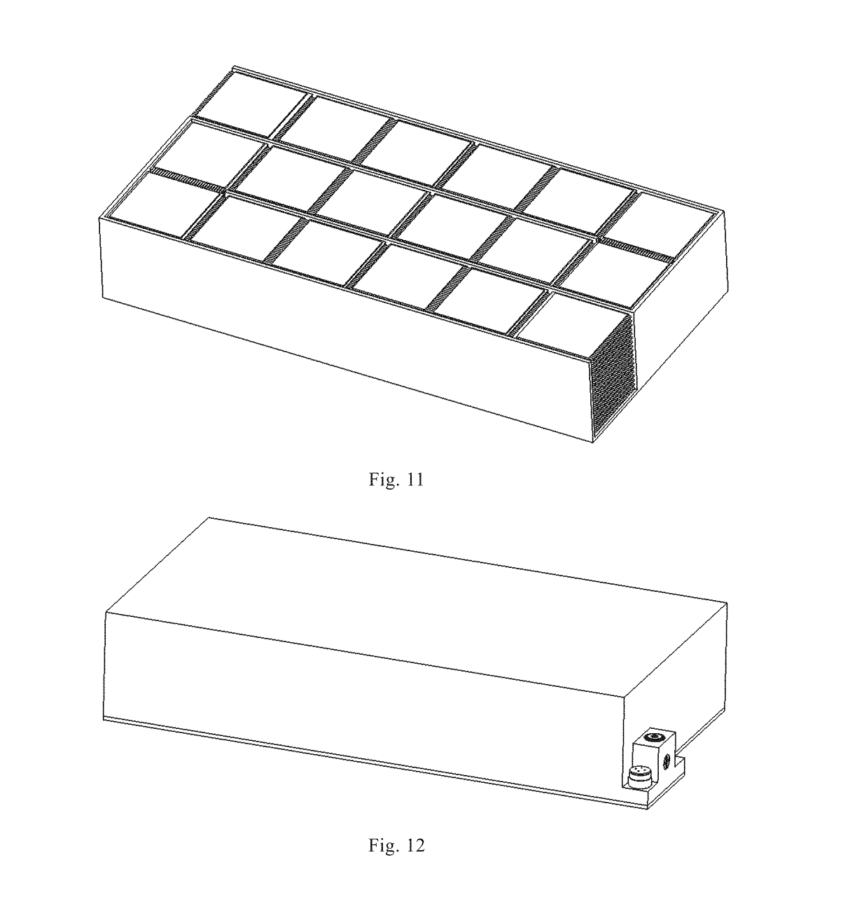

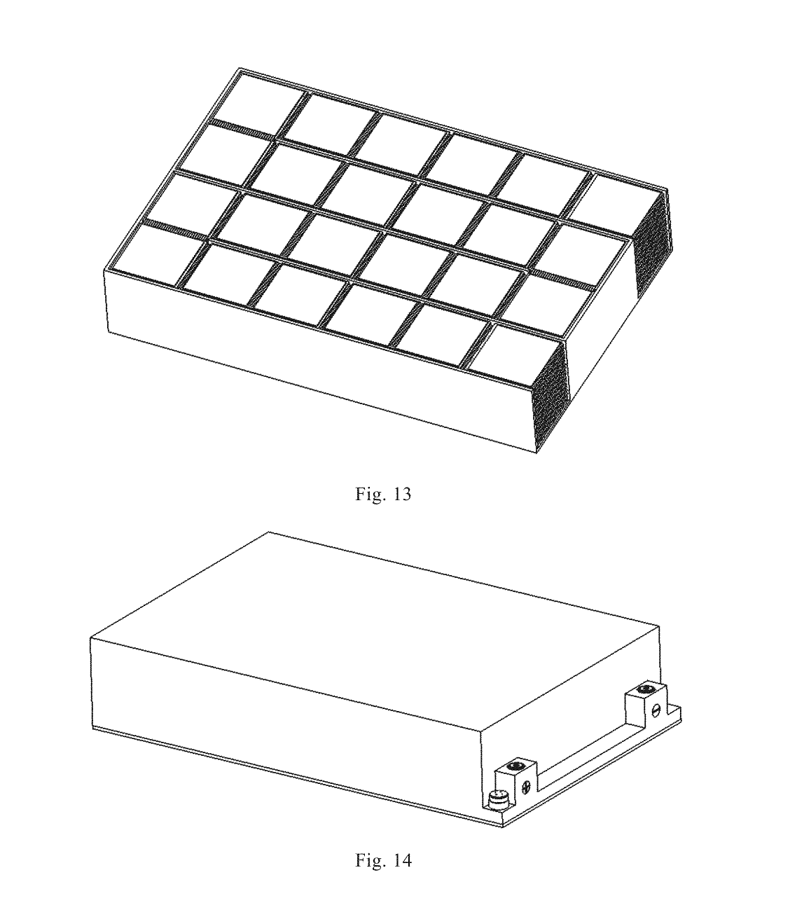

Each of the cells of the modular multi-cell battery as prepared above can be regarded as a 2V single battery. Thus, the above-mentioned modular multi-cell battery is a 24V battery as it has 12 cells. Accordingly, modular batteries of different voltages can be prepared by adjusting the number of the cells, such as modular batteries of 2 to 48V, or the like. For example, FIG. 10 is a schematic depiction of a 24V battery according to an embodiment of the present application; FIG. 11 and FIG. 12 are a schematic depiction of a 36V battery according to an embodiment of the present application; and FIG. 13 and FIG. 14 are a schematic depiction of a 48V battery according to an embodiment of the present application.

Aiming to address the problems of electrolyte stratification, incapability for high-rate charging and discharging, poor anti-vibration ability, serious environmental pollution during production, among others, which are associated with traditional lead-acid batteries, the present inventors modify the production process of 2V modular multi-cell batteries into a production process that incorporates lead-coated extruded grid technique, bipolar electrode plate technique, pressure frame technique, novel sealing technique and cell modular production technique.

Based on a 2V single battery, the present application allows making 2 to 48 V modular batteries by assembling bipolar electrode plates in series. The use of the technique whereby a lead-coated glass fiber is made into a lead wire which is then woven into a lead grid allows greatly enhancing the anti-corrosion performance of the grid and thus considerably increasing the cycling life of the battery. The use of the quasi-bipolar electrode plate technique that achieves connection of single batteries in series by means of direct connection of the lead grid allows achieving reliable connection of the internal single batteries without the problem associated with tab welding. This solves the problem of concentration polarization phenomenon occurring in conventional batteries and permits high-power discharging and fast charging of the battery. The use of the pressure frame structure technique allows solving the problems of electrode plate deformation due to expansion and of easy peeling of the active materials, while significantly enhancing the anti-vibration and anti-impact capabilities of the battery. Moreover, injection of adhesive or asphalt between the cells to achieve sealing of the cells in the battery core addresses the problem of inconsistency in self-discharging between the cells of the battery and between the single batteries resulting from a flow of liquid and gas between the cells of the battery, which allows greatly increasing the charge retention capability and the consistency of the battery.

The above-mentioned techniques, in effective combination, give the 2V modular multi-cell batteries novel characteristics of high specific energy, high-power charging and discharging, strong anti-vibration capability, long cycling life, among others, which are unmatched by conventional battery technologies. Furthermore, the above-mentioned techniques ensure that other excellent performances of conventional lead-acid batteries are not affected, with some of the performances equating to those of lithium batteries.

The foregoing describes the present application in further detail in conjunction with specific implementations, and should not be considered as limiting the concrete practice of the present application thereto. For those of ordinary skill in the art to which the present application belongs, several simple derivations or substitutions may be made without departing from the inventive concept of the present application.

1. A modular multi-cell battery, comprising:
a battery core comprising a bipolar electrode plate, a positive terminal electrode plate, a negative terminal electrode plate and a separator which are provided in plural numbers respectively; wherein one half of the bipolar electrode plate is coated with a positive active material to serve as a positive electrode plate, and the other half is coated with a negative active material to serve as a negative electrode plate, with a gap in between the positive electrode plate and the negative electrode plate, which is not coated with either the positive active material or the negative active material, and which is configured for electrical connection between cells; the positive terminal electrode plate is coated with a positive active material to serve as a positive electrode plate, one side of the positive terminal electrode plate having a region which is left uncoated with the positive active material and which serves as a positive electrode output terminal of the battery core; the negative terminal electrode plate is coated with a negative active material to serve as a negative electrode plate, one side of the negative terminal electrode plate having a region which is left uncoated with the negative active material and which serves as a negative electrode output terminal of the battery core; and the separator serves to absorb acid so that the bipolar electrode plate, the positive terminal electrode plate and the negative terminal electrode plate undergo electrochemical reactions to generate electricity;
a pressure frame having a bottom side face and a plurality of lateral side faces and being configured for housing the battery core;
a pressure cover plate, which in cooperation with the pressure frame, serves to press-fit the battery core and form the cells of the battery, the cells being separated by an insulation material;
a battery case and a battery cover, which serve to encapsulate the battery core having been press-fit by the pressure frame and the pressure cover plate;
wherein the positive terminal electrode plate, the bipolar electrode plate and the negative terminal electrode plate are placed horizontally and alternately, and the separator is placed between an upper electrode plate and a lower electrode plate;
wherein a hole is formed at a cell boundary on the exterior of a side face of the pressure frame for injecting the insulation material.

2. (canceled)

3. The modular multi-cell battery according to claim 1, wherein the pressure frame further has a raised edge, and the pressure cover plate further has a groove that engages with the raised edge.

4. The modular multi-cell battery according to claim 1, wherein an inward groove is formed at a cell boundary on the interior of the bottom side face and the lateral side faces of the pressure frame to provide a better sealing effect between the cells when injecting the insulation material.

5. The modular multi-cell battery according to claim 1, wherein the pressure cover plate has a safety valve hole in the same number as that of the cells, the safety valve hole being configured for acid injection into and gas exhaustion from the respective cell.

6. The modular multi-cell battery according to claim 5, wherein the safety valve hole is equipped with a safety valve.

7. The modular multi-cell battery according to claim 1, wherein the pressure cover plate and the pressure frame engages with each other, with epoxy adhesive being applied to the joint of the pressure cover plate and the pressure frame for bonding the pressure cover plate and the pressure frame and isolating the cells from the outside.

8. The modular multi-cell battery according to claim 1, wherein the positive terminal electrode plate is placed in a first cell or a last cell, and correspondingly, the negative terminal electrode plate is placed in the last cell or the first cell; the modular multi-cell battery also comprises two cast terminals respectively for electrical connection to the region of the positive terminal electrode plate or the negative terminal electrode plate not coated with the active material and respectively serving as the positive electrode output terminal or the negative electrode output terminal of the modular multi-cell battery.

9. The modular multi-cell battery according to claim 1, wherein epoxy adhesive is applied to the joint of the battery case and the battery cover, and the battery case further has a safety valve hole, the safety valve hole being equipped with a safety valve.

10. The modular multi-cell battery according to claim 1, wherein:
the bipolar electrode plate is of a quasi-bipolar structure, which is fabricated using a solid-state extrusion process whereby a lead-coated glass fiber is made into a lead wire which is then woven into a lead grid, and one half of the lead grid is coated with a positive active material to serve as a positive electrode plate, and the other half of the lead grid is coated with a negative active material to serve as a negative electrode plate, with a gap of about 10 mm between the positive active material and the negative active material of the bipolar electrode plate, which is configured for wire connection between cells;
the positive terminal electrode plate is fabricated using a solid-state extrusion process whereby a lead-coated glass fiber is made into a lead wire which is then woven into a lead grid, and the lead grid is coated a the positive active material, with one side of the electrode plate having a region which is left uncoated with the positive active material and which serves as a terminal of the positive terminal electrode plate; and
the negative terminal electrode plate is fabricated using a solid-state extrusion process whereby a lead-coated glass fiber is made into a lead wire which is then woven into a lead grid, and the lead grid is coated with a negative active material, with one side of the electrode plate having a region which is left uncoated with the negative active material and which serves as a terminal of the negative terminal electrode plate.
